(19) United States
(12) Patent Application Publication
(10) Pub. No.: US 2017/0177848 A1
(43) Pub. Date: Jun. 22, 2017

(54) ELECTRONIC DEVICE HAVING A TOUCH SCREEN AND LOCKING AND UNLOCKING METHODS THEREOF

(71) Applicant: Huizhou TCL Mobile Communication Co., Ltd, Huizhou City, Guangdong (CN)

(72) Inventor: Jianfeng ZHU, Huizhou City, Guangdong (CN)

(73) Assignee: Huizhou TCL Mobile Communication Co., Ltd, Huizhou City, Guangdong (CN)

(21) Appl. No.: 15/128,359

(22) PCT Filed: Apr. 25, 2016
(86) PCT No.: PCT/CN2016/080109

§ 371 Date: Sep. 22, 2016

(30) Foreign Application Priority Data
Jul. 28, 2015 (CN) 2015104547163

(51) Int. Cl. G06F 21/32; G06K 9/00

(52) U.S. Cl. CPC G06F 21/32; G06K 9/0002

(57) ABSTRACT

An electronic device having a touch screen, together with the associated locking and unlocking methods is disclosed. The locking method includes: acquiring the capacitance sensing data that is collected by the touch screen after it is pressed by a user's palm; converting the capacitance sensing data from analog to digital to obtain an outline of the palm; obtaining the palm's characteristic data according to the outline of the palm; storing the characteristic data and setting it as a key of the electronic device; and locking the electronic device with the key. Thus, the electronic device according to the disclosure only needs to collect the palm's characteristic data and set it as the key of the electronic device without needing additional components. Furthermore, because the palm's characteristic data can be readily collected and identified, the electronic device can be locked and unlocked in a simple and convenient manner.

### TECHNICAL FIELD

This disclosure relates to information identification, and more particularly, to an electronic device having a touch screen and associated locking and unlocking methods thereof.

### BACKGROUND

A majority of smart devices now are typically equipped with a touch screen for ease of operation. And there exist a variety of methods for locking and unlocking the touch screen of a smart device, such as fingerprint identification, password, et cetera. While fingerprint identification is fairly simple to operate, the initial fingerprint entry and setting up process may be exceedingly complicated and additional plug-ins may be needed for entry of fingerprint, thus adding to the device cost. Though by way of password no additional hardware cost would be incurred, it may require the password be entered manually, so the password must be remembered, or the device may not be able to unlock.

There is, therefore, an urgent need to provide an electronic device that is equipped with a simple locking method and can also quickly unlock, without increasing its cost.

### SUMMARY

An electronic device having a touch screen and associated locking and unlocking methods are disclosed, which can lock the electronic device by presetting a palm's characteristic data as a key, collect the palm characteristic data of a current user and compare it against the key, and unlock the electronic device only when they are consistent, thereby effecting simple and quick locking and unlocking manipulations, without incurring additional hardware costs.

According to an aspect of the disclosure, a method of locking an electronic device having a touch screen is disclosed that comprises: acquiring the capacitance sensing data collected by the touch screen after it is pressed by a user's palm; converting the capacitance sensing data from analog to digital to obtain an outline of the palm; obtaining the palm's characteristic data according to the palm's outline; storing the characteristic data and setting it as a key of the electronic device; and locking the electronic device by the key.

The block of obtaining the palm's characteristic data according to the palm's outline may comprise: identifying whether the palm is of a left or a right hand, and obtaining at least one of a length of each finger of the palm, a distance from the middle finger of the palm to a center of a heel of the palm, and a width of the palm, as the characteristic data.

The block of obtaining at least one of the length of each finger of the palm, the distance from the middle finger of the palm to the center of the heel of the palm, and the width of the palm as the characteristic data may comprise: acquiring first pixel coordinates of a first feature point of the palm and second pixel coordinates of a second feature point of the palm, and obtaining the distance between the first and second feature points according to the first and the second pixel coordinates.

According to another aspect of the disclosure, a method of unlocking an electronic device having a touch screen is also disclosed that comprises: acquiring the capacitance sensing data that is collected by the touch screen after it is pressed by a user's palm; converting the capacitance sensing data from analog to digital to obtain an outline of the palm; obtaining the palm's characteristic data according to the palm's outline; accessing a key of the electronic device; comparing the characteristic data against the key to determine whether they are consistent; and unlocking the electronic device if they are consistent.

The block of obtaining the palm's characteristic data according to the palm's outline may comprise: identifying whether the palm is of a left or a right hand, and obtaining at least one of a length of each finger of the palm, a distance from the middle finger of the palm to a center of a heel of the palm, and a width of the palm as the characteristic data.

The block of obtaining at least one of the length of each finger of the palm, the distance from the middle finger of the palm to the center of heel of the palm, and the width of the palm as the characteristic data may comprise: acquiring first pixel coordinates of a first feature point of the palm and second pixel coordinates of a second feature point of the palm, and obtaining the distance between the first and second feature points according to the first and the second pixel coordinates.

According to yet another aspect of the disclosure, an electronic device having a touch screen is further disclosed that comprises: a touch screen configured to collect the first capacitance sensing data of a first palm of a user after it is pressed by the first palm; an analog-to-digital converter (ADC) module coupled to the touch screen and configured to convert the first capacitance sensing data from analog to digital to obtain an outline of the first palm; a processing module coupled to the ADC module and configured to obtain first characteristic data of the first palm according to the first palm's outline; and a storage module coupled to the processing module and configured to store the first characteristic data of the first palm and set it as a key of the electronic device, wherein the processing module may further lock the electronic device by the key.

The processing module may be configured to identify whether the first palm is of a left or a right hand according to the first palm's outline, and obtain, according to the first palm's outline, at least one of a length of each finger of the first palm, a distance from the middle finger of the first palm to a center of a heel of the first palm, and a width of the first palm as the first characteristic data.

The touch screen may be further configured to collect second capacitance sensing data of a second palm of the user after it is pressed by the second palm, while the ADC module may be configured to convert the second capacitance sensing data from analog to digital to obtain an outline of the second palm, the processing module may be configured to obtain second capacitance sensing data of the second palm according to the second palm's outline, and further compare the second characteristic data against the first characteristic data and unlock the electronic device only if they are consistent.

The processing module may be configured to identify whether the second palm is of a left or a right hand according to the second palm's outline, and obtain, according to the second palm's outline, at least one of a length of each finger of the second palm, a distance from the middle finger of the second palm to a center of a heel of the second palm, and a width of the second palm as the second characteristic data.

As compared to the prior art, the disclosure may have the following advantages. According to the method of locking an electronic device having a touch screen proposed by the disclosure, the touch screen may first collect the capacitance sensing data when it is pressed by a user's palm, then the collected capacitance sensing data may be converted from analog to digital to acquire an outline of the palm, so the palm's characteristic data can be obtained according to the palm's outline and stored and set as a key of the electronic device, thereby the electronic device can be locked with the key. In this way, no additional components would be needed, and because the palm's characteristic data can be readily collected and identified, the locking and unlocking operations could be comparatively easy and convenient.

### BRIEF DESCRIPTION OF THE DRAWINGS

FIG. 1 shows a block diagram of an electronic device having a touch screen according to a first embodiment of the disclosure.

FIG. 2 illustrates the distribution of the touch electrodes of the touch screen of the electronic device shown in FIG. 1.

FIG. 3 illustrates the change of capacitance values of the touch screen of the electronic device shown in FIG. 1, before and after the touch screen is pressed by a palm.

FIG. 4 illustrates an outline of the palm as obtained after the touch screen of the electronic device shown in FIG. 1 is pressed by a palm.

FIG. 5 is a flowchart illustrating a method of locking an electronic device having a touch screen according to a second embodiment of the disclosure.

FIG. 6 is a flowchart illustrating a method of unlocking an electronic device having a touch screen according to a third embodiment of the disclosure.

### DETAILED DESCRIPTION

To render the objectives, technical solutions, and advantages of the disclosure definite and unambiguous, hereinafter the disclosure will be described in greater detail in connection with particular embodiments and the accompanying drawings. It, however, should be appreciated that the particular embodiments as discussed are merely meant to better illustrate, but not to limit, the disclosure.

Today electronic devices provided with a touch screen are more and more widely used and are typically operated in a touch-based manner. In view of personal information security, often times electronic devices may be locked by some means, of which, for example, two most commonly used means may include password and fingerprint. However, the former may require the user to remember the password, and the unlocking procedure, i.e., entry of password, is comparatively complicated, while the latter may require the electronic device to be installed with additional plug-ins which may add to the cost. In the disclosure an electronic device having a touch screen and associated locking and unlocking methods are proposed, which can effect the locking and unlocking of the electronic device to be performed in an easy manner, without needing additional components or plug-ins.

Referring to FIGS. 1 through 4. FIG. 1 shows a block diagram of an electronic device having a touch screen according to a first embodiment of the disclosure. Electronic device 1 may include a touch screen 11, an analog-to-digital converter (ADC) module 12, a processing module 13, and a storage module 14 that are coupled in succession. Touch screen 11 may be configured to collect first capacitance sensing data of a first palm of a user after it is pressed by the first palm. ADC module 12 may be configured to convert the first capacitance sensing data from analog to digital, to obtain an outline of the first palm. Processing module 13 may be configured to acquire the first characteristic data of the first palm according to the first palm's outline. And the storage module 14 may be configured to store the first characteristic data of the first palm and set it as a key of electronic device 1, while the processing module 13 may further be configured to lock the electronic device 1 by the key.

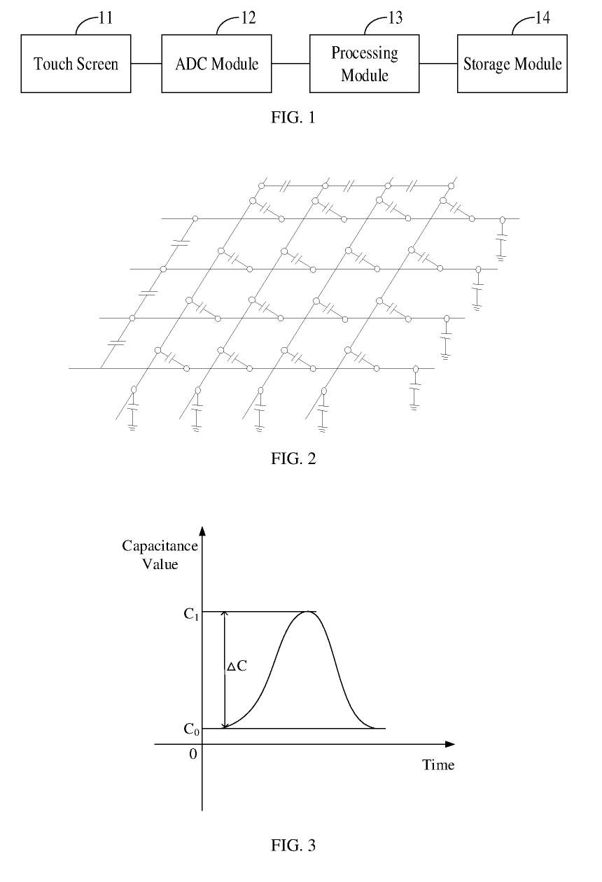

In one embodiment, the first characteristic data of the first palm can be acquired by the following means. Touch screen 11 may adopt a design of a capacitive touch screen; the distribution of the touch electrodes of the capacitive touch screen when untouched is shown in FIG. 2. When the user's hand presses down on the touch screen 11, the capacitance at the positions within the area covered by the palm where electrodes intersect (nodes) may change. For example, as shown in FIG. 3, the capacitance value of the touch screen 11 is C₀before it is pressed by the palm, while, when the palm presses down on the touch screen 11, the capacitance value of the position where the palm presses turns to C₁, so the touch screen 11 may collect the capacitance variation value ΔC at the node covered by the palm as the first capacitance sensing data of the first palm, and ΔC=C₀−C₁.

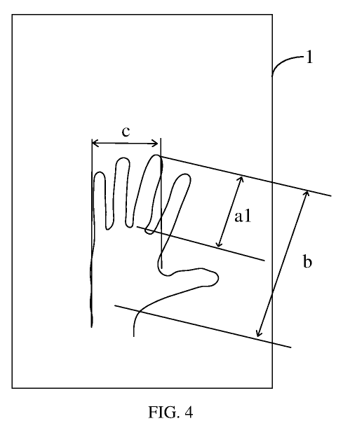

ADC module 12 of the electronic device 1 may acquire from the touch screen 11 the first capacitance sensing data, and convert the first capacitance sensing data from analog to digital, to obtain an outline of the first palm, of which one example is shown in FIG. 4. Processing module 13 may then acquire the first characteristic data of the first palm according to the first palm's outline. Specifically, processing module 13 may acquire the following information of the first palm as the first characteristic data. First, it may determine whether the first palm is of a left or a right hand according to the outline of the first palm, where typically a relative position of the thumb can be utilized to determine whether the first palm is of the left or the right hand. Second, the processing module 13 may acquire, according to the first palm's outline, a length of each finger of the first palm, a distance from the middle finger to a center of a heel of the first palm, and a width of the first palm, where these lengths or distance may all be measured as a length of pixels (resolution). Particularly in one embodiment, the processing module 13 may acquire the first pixel coordinates of a first feature point of the first palm and the second pixel coordinates of a second feature point of the first palm, and so calculate the distance between the first and second feature points according to the first and the second pixel coordinates. For example, the processing module 13 may acquire the pixel coordinates of the tip of the middle finger of the first palm as (m1, n1), and those of the center of the heel of the first palm as (m2, n2), thus the distance b from the middle finger to the center of the heel of the palm can be expressed as:

b=\sqrt{(m1−m2)²+(n1−n2)²}

Likewise, the above method can be repeatedly used to acquire the lengths of all five fingers as well as the width of the palm, an example of which is shown in FIG. 4, in which the length of the middle finger is a1, the distance from the middle finger to the center of the heel of the palm is b, and the width of the palm is c. In the current embodiment the storage module 14 may store the first characteristic data of the first palm as the key of the electronic device 1. The processing module 13 may employ at least one piece or a combination of the above characteristic data as the key of the electronic device 1. For example, the length a1 of the middle finger may be adopted as the key. In some embodiments, though, to improve the key security, all the first characteristic data can be employed altogether as the key, that is, the length of each finger, the distance from the middle finger to the center of the heel of the palm, together with the width of the palm may be collectively taken as the characteristic data of the key, and the electronic device 1 can be locked with the key.

After the electronic device 1 is locked by taking the first characteristic data of the first palm as the key, the electronic device 1 may need to be unlocked when it is called for. Hence, when pressed by a second palm of the user, the touch screen 11 may continue to collect the second capacitance sensing data of the second palm. Note, throughout the disclosure the first palm may refer to the palm that the user presses on the touch screen 11 to collect the characteristics data as the key of the electronic device 1, while the second palm may refer to the one the user presses on the electronic device to unlock the electronic device. Thus, terms “first”, “second” constitute no substantial meanings and shall not be perceived as distinguishing one from the other. ADC module 12 may further be configured to convert the second capacitance sensing data from analog to digital, to obtain an outline of the second palm. The processing module 13 may further be configured to acquire the second characteristic data of the second palm according to the second palm's outline. The processing module 13 may acquire the second characteristic data of the second palm by a manner in common with acquiring the first characteristic data of the first palm.

Processing module 13 may then compare the second characteristic data against the first characteristic data, and, if they are consistent with each other, unlock the electronic device 1. The processing module 13 may compare the second to the first characteristic data in an one-by-one basis, and unlock the electronic device 1 only when the second characteristic data matches entirely with the first characteristic data, then the electronic device 1 can enter an interface for normal use; otherwise if the second characteristic data is not an exact match of the first characteristic data, the processing module 13 can pop up notifications on the touch screen 11, for example, by voice broadcasts, text prompts, et cetera.

To summarize, according to the embodiment the electronic device 1 may first acquire through the touch screen 11 the first capacitance sensing data of the user's first palm that is collected after the touch screen 11 is pressed by the first palm. The ADC module 12 may then convert the first capacitance sensing data from analog to digital to obtain the outline of the first palm. The processing module 13 then can acquire the first capacitance sensing data of the first palm according to the first palm's outline. The storage module 14 can further store the first characteristic data and set it as the key of the electronic device 1, while the processing module 13 may lock the electronic device 1 with the key. Likewise, to unlock, the electronic device 1 may in the same manner collect the palm's characteristic data, compare the collected second characteristic data of the second palm against the first characteristic data of the first palm, and unlock the electronic device only if the comparison result indicates consistency. As a result, the electronic device 1 can be locked and unlocked in an easy and convenient manner without needing additional components or plug-ins.

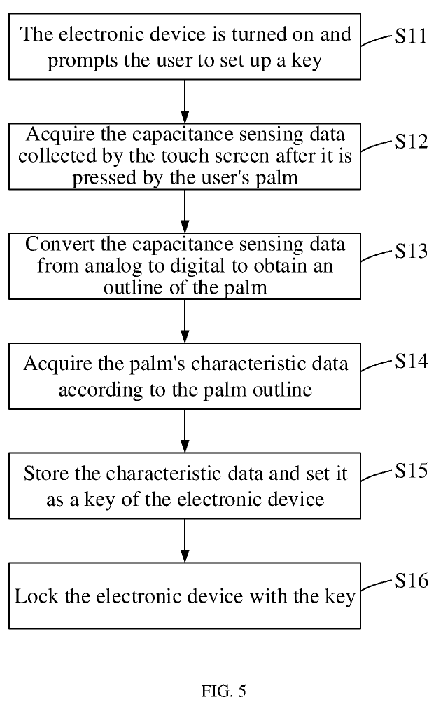

Referring now to FIG. 5, a method of locking an electronic device having a touch screen according to a second embodiment is depicted. The following description of the method is rendered in connection with the electronic device having a touch screen as discussed in the above embodiment. The method may include the following blocks.

At S11, the electronic device 1 may be turned on and may prompt the user to set up a key.

The electronic device 1 may be equipped with a capacitive touch screen. If it is turned on and no key is set, the electronic device 1 can automatically pop up a window for setting up a key, or the user can manually select to set up the key. With the former, if the user clicks to select “Yes”, a key-setting interface may be entered, otherwise if the user clicks to select “No”, the key setting interface would not be entered and the electronic device may turn to a normal operating interface. If the electronic device 1 has already been set up with a key, it may prompt the user to input a password or a corresponding key, the contents of which will be elaborated in the subsequent embodiment and thus will not be detailed herein.

At S12, the method includes acquiring the capacitance sensing data collected by the touch screen 11 after it is pressed by the user's palm.

After the user selects “Yes”, the electronic device 1 may enter a key-setting interface, which, in this case, can be a floating blank window. When the user's palm presses the touch screen 11 of the electronic device 1, the capacitance value of the touch screen 11 may change, so the electronic device 1 can acquire the capacitance sensing data of the touch screen 11, i.e., the capacitance variation value ΔC, ΔC=C₀−C₁, where C₀represents the capacitance value of the touch screen 11 before it is pressed by the user's palm, while C₁ represents the capacitance value of the touch screen 11 after it is pressed. In some embodiments, multiple users can press their palms on the touch screen 11 and the corresponding capacitance sensing data can be collected and stored respectively.

At S13, the method includes converting the capacitance sensing data from analog to digital to obtain an outline of the palm.

Specifically, the ADC module 12 may convert the capacitance sensing data from analog to digital to obtain the outline of the palm, an example of which is shown in FIG. 4.

At S14, the method includes acquiring the characteristic data of the palm according to the palm's outline.

Specifically, the processing module 13 acquiring the characteristic data of the palm according to the palm's outline may comprise: identifying whether the palm is of a left or a right hand according to the relative position of the thumb to the palm, and acquiring, according to the palm's outline, a length of each finger on the palm, a distance from the middle finger to a center of a heel of the palm, and a width of the palm. In some embodiments, other characteristic data can also be obtained, such as a distance from each finger to the center of the heel of the palm. At least one or a combination of these data can be adopted as the characteristic data of the palm that may serve as the unique identification information for the palm.

In one embodiment, the above data, including the length of each finger, the distance from the middle finger to the center of the heel of the palm, and the width of the palm, may all be measured as a length of the pixels on the touch screen 11. For example, the first pixel coordinates of a first feature point of the palm and the second pixel coordinates of a second feature point of the palm can first be acquired, thus the distance between the first and second feature points can be readily calculated according to the first and the second pixel coordinates.

At S15, the method includes storing the characteristic data as a key of the electronic device 1.

Specifically, the above characteristic data may be selectively adopted as the key and stored in a key register of the electronic device 1. To improve the security of the key, typically all of the acquired data, including the length of each finger of the palm, the distance from the middle finger to the center of the heel of the palm, and the width of the palm, may be collectively employed as the key to lock the electronic device 1. Therefore, only when all characteristic data of the palm used to unlock matches entirely with the characteristic data contained in the key can the electronic device be unlocked, so that the security of the electronic device 1 can be greatly improved. It is worth mentioning that, the key of the electronic device 1 can be altered at any time according to practical needs, further adding to the security and flexibility.

At S16, the method includes locking the electronic device by the key.

Specifically, all three parameters, including the distance from the middle finger to the center of heel of the palm, the length of each finger, and the width of the palm, may be employed altogether as the characteristic data of the key. So after boot-up, the electronic device 1 may need to match the key in order to enter the corresponding interface. In some embodiments, the key can also be used to lock only a certain application program, a certain event, or a certain operating interface. Additionally, different keys corresponding to different users can be set respectively so that a same electronic device 1 can be shared by multiple specified users, and each user can enter only the specified operating interface, thereby personal information of different users can be securely protected.

To summarize, according to the current embodiment, the electronic device 1 only needs to collect the characteristic data of the palm and set it as the key to lock the electronic device 1, thereby the electronic device 1 can be easily and conveniently locked without needing additional components or plug-ins.

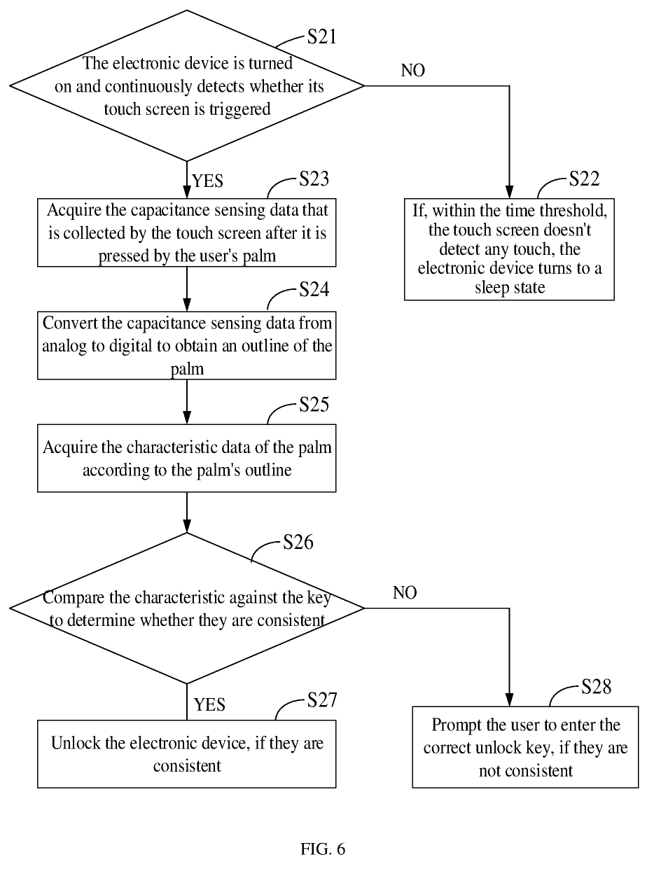

Referring also to FIG. 6, a method of unlocking an electronic device having a touch screen according to a third embodiment is depicted. The method may be conducted after the electronic device 1 in the above embodiment is locked and then needs to be unlocked for use. The unlocking method may include the following blocks.

At S21, the electronic device 1 may be turned on and may detect continuously whether the touch screen 11 is triggered.

The electronic device 1 may preset a time threshold. After the electronic device 1 is turned on while still locked, the touch screen 11 may scan continuously within the time threshold to determine whether the touch screen 11 is touched. If no touch is detected during the time threshold, S22 may then be entered. Otherwise if the touch screen 11 is triggered, then S23 may be entered.

At S22, because the touch screen 11 doesn't detect any touch and thus is not triggered within the time threshold, the electronic device 1 may turn to a sleep state.

Specifically, if no touch is detected during the time threshold, the electronic device 1 may directly enter the sleep state to lower the power consumption, and the touch screen 11 may continue to detect touch in the subsequent time cycle.

At S23, the method includes acquiring the capacitance sensing data collected by the touch screen 11 after it is pressed by the user's palm.

If within the time threshold the touch screen 11 detects a touch, the touch screen 11 can collect the capacitance sensing data triggered by the touch.

In some embodiments, if the touch screen 11 detects a touch within the time threshold, the electronic device 1 can prompt the user to press his palm on the touch screen 11. For example, the touch screen 11 may pop up a diagram of a hand to prompt the user to press his palm within the delineation of the diagram. If within a preset time threshold the diagram is not pressed by a palm, then the electronic device 1 may remain in the sleep state, that is, the electronic device 1 may decide that the touch screen 11 is pressed by mistake, so it will not perform any operations but just remain in the sleep state to prevent the electronic device 1 from collecting the sensing data of the touch screen 11 when only an inadvertent touch occurs, thereby further lowering the power consumption.

At S24, the method includes converting the capacitance sensing data from analog to digital to obtain an outline of the palm.

At S25, the method includes acquiring the characteristic data of the palm according to the palm's outline.

Blocks S24-S25 resemble blocks S13-S14, and thus will not be detailed again.

At S26, the method includes comparing the characteristic data against the key to determine whether they are consistent with each other.

The characteristic data contained in the key may be compared in a one-by-one basis with the characteristic data of the current palm, and, if they are consistent, block S27 may be entered. Otherwise if they are not consistent, block S28 may be entered.

In some embodiments, in the electronic device 1 may be stored an error threshold, so that if the deviation of the characteristic data of the current key from the characteristic data of the current palm is within the error threshold, block S27 may still be entered. Or, if the deviation of the characteristic data of the current key from the characteristic data of the current palm goes beyond the error threshold, then block S28 may be entered.

In some embodiments, if the electronic device 1 has stored the keys multiple corresponding users, then the characteristic data of the current palm may be compared to the keys of different users respectively. If the characteristic data of the current palm matches the key of a certain user, block S27 could be turned to unlock the electronic device 1. Or, if the characteristic data does not match any of the keys stored in the electronic device 1, block S28 may be turned to.

At S27, if the characteristic data is consistent with the key, the electronic device 1 may be unlocked.

Specifically, if the palm's characteristic data of the current user is consistent with the characteristic data contained in the key, the electronic device 1 can be unlocked. Alternatively, if the deviation of the palm's characteristic data of the current user from the characteristic data contained in the key is within the error threshold, the electronic device 1 can also be unlocked. Alternatively, if the palm's characteristic data of the current user is consistent with the characteristic data of a certain key stored in the key register, the electronic device 1 may be unlocked.

At S28, if the characteristic data is not consistent with the key, the user may be prompted to re-input the correct unlock key.

If the palm's characteristic data of the current user is not consistent with the characteristic data contained in the key, or if the deviation of the palm's characteristic data of the current user from the characteristic data contained in the key is beyond the error threshold, then the electronic device 1 may prompt the user that the current key is a mistake and needs to be re-entered. In some embodiments, the electronic device 1 can preset a number of unlock input times, so that if the user attempts to unlock the electronic device 1 the preset number of times within the preset time threshold but the characteristic data is never consistent with the characteristic data contained the key, then the electronic device 1 may be temporarily locked from accepting any more unlock inputs for a preset time threshold. That suggests that further unlock inputs can only be re-entered past the preset time threshold, thereby the electronic device 1 can be avoided from continuously comparing the characteristic data and thus the power consumption of the electronic device 1 can be effectively reduced.

An electronic device is further disclosed in the disclosure that includes a touch screen, a processor, a storage, and a bus. The touch screen, the processor, and the storage may be coupled to the bus, respectively. The storage may be configured to store a program, while the processor may be configured to execute the program. The program may be configured to:

acquire first capacitance sensing data collected by the touch screen after it is pressed by a first palm of a user;

convert the first capacitance sensing data from analog to digital to obtain an outline of the first palm;

acquire characteristic data of the first palm according to the first palm's outline, including: identify whether the first palm is of a left or a right hand; acquire first pixel coordinates of a first feature point of the first palm; acquire second pixel coordinates of a second feature point of the first palm; and obtain the distance between the first and second feature points according to the first and the second pixel coordinates; wherein the characteristic data may include at least one of a length of each finger on the first palm, a distance from the middle finger of the first palm to a center of a heel of the first palm, and a width of the first palm;

store the characteristic data as a key of the electronic device; and

lock the electronic device by the key.

The program may be further configured to:

access the key of the electronic device;

acquire second capacitance sensing data of a second palm of the user after the touch screen is pressed by the second palm, convert the second capacitance sensing data from analog to digital to obtain an outline of the second palm, and acquire the second characteristic data of the second palm according to the second palm's outline,

compare the second characteristic data of the second palm against the key and determine whether they are consistent; and

unlock the electronic device, if they are consistent.

In conclusion, according to the method of unlocking the electronic device 1 having the touch screen 11, the touch screen 11 may first collect the capacitance sensing data after it is pressed by the user's palm, then the collected capacitance sensing data may be converted from analog to digital to acquire an outline of the palm, and the palm's characteristic data can be obtained according to the palm outline and stored as the key of the electronic device 1, so the electronic device 1 can be locked with the key. Thereby, no additional components would be needed, and because the palm's characteristic data can be readily collected and identified, the electronic device 1 can be locked and unlocked in a comparatively easy and convenient manner.

The above description merely depicts some exemplary embodiments of the disclosure, but is not limiting the scope of the disclosure. Any equivalent structural or flow transformations made to the disclosure, or any direct or indirect applications of the disclosure on any other related fields, shall all be covered within the protection of the disclosure.

1. A method of locking an electronic device having a touch screen, comprising:
acquiring capacitance sensing data collected by the touch screen after the touch screen is pressed by a palm of a user;
converting the capacitance sensing data from analog to digital to obtain an outline of the palm;
obtaining characteristic data of the palm according to the outline of the palm;
storing the characteristic data of the palm and setting the characteristic data of the palm as a key of the electronic device; and
locking the electronic device by the key.

2. The method according to claim 1, wherein obtaining the characteristic data of the palm according to the outline of the palm comprises:
identifying whether the palm is of a left hand or a right hand; and
acquiring at least one of a length of each finger of the palm, a distance from a tip of a middle finger of the palm to a center of a heel of the palm, and a width of the palm as the characteristic data.

3. The method according to claim 2, wherein acquiring at least one of the length of each finger of the palm, the distance from the tip of the middle finger to the center of the heel of the palm, and the width of the palm as the characteristic data comprises:
acquiring first pixel coordinates of a first feature point of the palm;
acquiring second pixel coordinates of a second feature point of the palm; and
obtaining a distance between the first feature point and the second feature points according to the first pixel coordinate and the second pixel coordinate.

4. A method of unlocking an electronic device having a touch screen, comprising:
acquiring capacitance sensing data collected by the touch screen after the touch screen is pressed by a palm of a user;
converting the capacitance sensing data from analog to digital to obtain an outline of the palm;
obtaining the characteristic data of the palm according to the outline of the palm;
accessing a key of the electronic device;
comparing the characteristic data of the palm against the key; and
unlocking the electronic device when the characteristic data of the palm is consistent with the key.

5. The method according to claim 4, wherein obtaining the characteristic data of the palm according to the outline of the palm comprises:
identifying whether the palm is of a left hand or a right hand;
acquiring at least one of a length of each finger of the palm, a distance from a tip of a middle finger of the palm to a center of a heel of the palm, and a width of the palm as the characteristic data.

6. The method according to claim 5, wherein acquiring at least one of the length of each finger of the palm, the distance from the tip of the middle finger to the center of the heel of the palm, and the width of the palm as the characteristic data comprises:
acquiring first pixel coordinates of a first feature point of the palm;
acquiring second pixel coordinates of a second feature point of the palm; and
obtaining a distance between the first feature point and second feature point according to the first pixel coordinate and the second pixel coordinate.

7. An electronic device having a touch screen, comprising:
a touch screen configured to collect first capacitance sensing data of a first palm of a user after the touch screen is pressed by the first palm;
an analog-to-digital converter (ADC) coupled to the touch screen and configured to convert the first capacitance sensing data from analog to digital to obtain an outline of the first palm;
a processor coupled to the ADC and configured to acquire first characteristic data of the first palm according to the outline of the first palm; and
a memory storage coupled to the processor and configured to store the first characteristic data of the first palm as a key of the electronic device;
wherein the processor is further configured to lock the electronic device with the key.

8. The electronic device according to claim 7, wherein the processor is configured to identify whether the first palm is of a left hand or a right hand according to the outline of the first palm, and acquire, according to the outline of the first palm, at least one of a length of each finger of the first palm, a distance from a tip of a middle finger of the first palm to a center of a heel of the first palm, and a width of the first palm as the first characteristic data.

9. The electronic device according to claim 8, wherein the touch screen is further configured to collect second capacitance sensing data of the a second palm of the user after the touch screen is pressed by the second palm, the ADC is further configured to convert the second capacitance sensing data from analog to digital to obtain an outline of the second palm, and the processor is further configured to obtain second characteristic data of the second palm according to the outline of the second palm, compare the second characteristic data against the first characteristic data, and unlock the electronic device when the second characteristic data is consistent with the first characteristic data.

10. The electronic device according to claim 9, wherein the processor is configured to identify whether the second palm is of a left hand or a right hand according to the outline of the second palm, and acquire, according to outline of the second palm, at least one of a length of each finger of the second palm, a distance from a tip of a middle finger of the second palm to a center of a heel of the second palm, and a width of the second palm as the second characteristic data.

11. The method according to claim 3, wherein the distance between the first feature point and the second feature point is measured as a length of pixels on the touch screen.

12. The method according to claim 1, further comprising, before acquiring the capacitance sensing data collected by the touch screen:
prompting the user to set up the key for the electronic device.

13. The method according to claim 4, wherein comparing the characteristic data of the palm against the key comprises:
presetting an error threshold;
when a deviation of the characteristic data from the key is within the preset error threshold, determining that the characteristic data is consistent with the key; or
when a deviation of the characteristic data from the key is beyond the preset error threshold, determining that the characteristic data is inconsistent with the key.

14. The method according to claim 6, wherein the distance between the first feature point and the second feature point is measured as a length of pixels on the touch screen.

15. The electronic device according to claim 9, wherein the processor is further configured to preset an error threshold, and, when a deviation of the second characteristic data from the first characteristic data is within the preset error threshold, determine the second characteristic data is consistent with the first characteristic data; or when the deviation of the second characteristic data from the first characteristic data is beyond the preset error threshold, determine the second characteristic data is inconsistent with the first characteristic data.

16. The electronic device according to claim 7, wherein the electronic device is configured to preset a time threshold, and the touch screen is further configured to detect continuously within the time threshold whether a touch is detected and enter a sleep state when no touch is detected.

17. The electronic device according to claim 16, wherein the touch screen is further configured to continue to detect whether the touch screen is touched in a subsequent time cycle.

18. The electronic device according to claim 16, wherein the touch screen is further configured to collect the capacitance sensing data when the touch is detected.

19. The electronic device according to claim 16, wherein the touch screen is further configured to, when the touch is detected, pop up a diagram of a hand to prompt the user to press his palm within a delineation of the diagram, and when within a preset time threshold the diagram is not pressed, the processor determines the touch is inadvertent and remains in the sleep state.
